(19) United States
(12) Patent Application Publication
(10) Pub. No.: US 2020/0089336 A1
(43) Pub. Date: Mar. 19, 2020

(54) Physically Navigating a Digital Space Using a Portable Electronic Device

(71) Applicants: Adrian Westaway, London (GB); Clara Gaggero, London (GB)

(72) Inventors: Adrian Westaway, London (GB); Clara Gaggero, London (GB)

(21) Appl. No.: 16/494,175

(22) PCT Filed: Mar. 15, 2018
(86) PCT No.: PCT/GB2018/050676

§ 371 Date: Sep. 13, 2019

(30) Foreign Application Priority Data
Mar. 16, 2017 (GB) 1704191.4

(51) Int. Cl. G06F 3/0346; G06F 3/0481; G06F 3/0485; G06F 3/0487; G06F 3/03; G06F 3/0484; G06F 1/16

(52) U.S. Cl. CPC G06F 3/0346; G06F 3/04815; G06F 3/0485; G06F 2200/1637; G06F 3/0304; G06F 3/04845; G06F 1/1626; G06F 3/0487

(57) ABSTRACT

Software which allows users of a portable electronic device 201 to intuitively switch between programs by moving the device from one location 103 to another 101,102. The motion is sensed by the device and used to determine how and when to change the program visible on the display of the device. A plurality of programs can effectively be anchored virtually to a physical space, allowing the user to move the device to that physical space, which will update the program visible on the display. The user can choose to digitally move content from one program to another in a natural way.

### CROSS-REFERENCE TO RELATED APPLICATIONS

This application is a National Stage Application under 35 U.S.C. § 371 of PCT Application No. PCT/GB2018/050676, filed Mar. 15, 2018, which claims priority to European Patent Application No. 201704191.4, filed Mar. 16, 2017, the entire disclosures of which are hereby incorporated by reference.

### TECHNICAL FIELD

The present disclosure relates to an intuitive means of physically navigating a digital space through motion sensed on an electronic device and particularly, but not exclusively, on a portable electronic device. An aspect of the invention relates to a method of controlling an electronic device, including but not limited to a portable electronic device, having a display and access to motion sensors either inside or in addition to the device. A further aspect of the invention relates to an electronic device capable of being controlled using the position of the device. Such portable electronic device may include mobile (cell) phones, portable computers and tablets. A further yet aspect of the invention relates to a computer readable medium having stored instructions executed by a processor of the portable electronic device and causes the portable electronic device to implement the method.

### BACKGROUND

Electronic devices, including portable electronic devices, have gained widespread use as a means of performing tasks for work and leisure. Portable electronic devices in very wide use include mobile telephone handsets and tablet computers. It is often difficult for the user of the electronic device to perform multiple tasks at the same time. For example, users may want to write an email in one application, whilst checking information on their calendar in a separate application, and checking information in a report on another application.

The function of a portable electronic device is well known, whereby reference can be made to publicly available literature, for example US 212/019 0301, US 2011/025 2358, US 2002/014 0666 and US 2004/016 9374. Such portable electronic devices are generally battery powered and optionally can be connected to the mains electricity supply but this definition does not preclude a device powered solely by mains electricity as long as the display is readily movable, especially if it is hand-held.

Generally, at any one time, a portable electronic device can run multiple programs. However, often only one program is run in the foreground at any one time, the remaining programs operating in the background. A visual display generated by that foreground program is displayed on the screen and inputs from and to the input/output (I/O) devices are active to interact with the foreground program. Visual displays generated by the programs run in the background are generally not displayed at all or, if displayed, occupy only part of the screen. It is, of course, possible to change which program is running in the foreground on a portable electronic device and which is running in the background but, generally, the commands associated with such switching are unnatural and time consuming, often requiring the user to press real or virtual buttons and/or scroll through a carousel of open programs every time they switch. This creates a cognitive load on the user and diverts their attention from the task at hand. The same problem arises in many other scenarios such as, for example, the switching between various electronic documents or parts of such documents in a single program, a more specific example being switching between different documents in a word processing program.

The above problem also limits the potential of multitasking on a portable electronic device, which is something an increasing number of people are trying to do.

US 2002/014 0666 describes an arrangement for detecting the motion of a mobile electronic device and changing the display of the device based on the detected motion. For example: zooming in or out of a document or picture, moving the viewpoints when viewing a virtual three-dimensional object, moving between different chat rooms by engaging a gating button and moving the device until the 2nd chat room is displayed, whereupon the gating button can be released to display the 2nd chat room.

US 2011/025 2358 describes a mobile device running a computer program that allows an image of part of a digital document to be displayed on screen. By moving the device, it can display different parts of the document on the screen. Also, by moving the device closer to or further away from the user or from a surface, the part displayed can be magnified or diminished in size.

US 2012/019 0301 describes an arrangement for interacting between a portable electronic device and a stationary computing device. In particular, the motion of the portable electronic device can be detected on the stationary device to control the image displayed on the stationary device.

US 2004/016 9674 describes the control of a portable electronic device having a screen and a motion sensor. A function is selected by a gesture from the user by touching the device, the gesture having at least a component of the 3 dimensions. The device detects the gesture provides a tactile feedback in response the gesture detection.

The present invention has been devised to mitigate or overcome at least some of the above-mentioned problems.

### SUMMARY OF THE INVENTION

According to a first aspect of the present invention there is provided a method of enabling control of a portable electronic device using the position of the portable electronic device in physical space, which device comprises a display, a memory, a processing unit adapted to process application code from one or more applications and to display one or more application windows on the display, the method comprising the steps of:

establishing a first position of the portable electronic device in physical space and defining said first position as a first application window position for displaying a first application window on the display of the portable electronic device, and

establishing a second position of the portable electronic device in physical space and defining said second position as a second application window position for displaying a second application window on the display of the portable electronic device,

whereby subsequent movement of the portable electronic device between the first and second positions is adapted to change an application window displayed on the display between the first application window and the second application window.

This approach is effective to allow a user's movement of the portable electronic device to form part of the user interface of the device in a way that is customisable by the user.

In embodiments, establishing a first or a second position may comprise placing the portable electronic device in said position, activating an application to be associated with the corresponding application window, and recording said position as the position associated with the corresponding application window.

A working region of physical space may then comprise at least the first position and the second position, with an application window area corresponding to the working region. The first position and the second position may be defined relative to the working region of physical space. Alternatively, the first position and the second position may be defined relative to a physical object.

In a second aspect, the invention provides a method of providing a user interface for a portable electronic device, which device comprises a display, a memory, a processing unit adapted to process application code from one or more applications and to display one or more application windows on the display, the method comprising the steps of:

recovering from the memory a first application window position defined for a first application window by a first position of the portable electronic device in physical space, and

moving the portable electronic device to the first application window position, whereupon the portable electronic device displays the first application window.

This approach provides an extremely effective user interface for a portable electronic device, as device position can be used as a primary tool in determining device display, and establishment of an active display window. This can simplify the user interface significantly for a user, as it reduces the need for touchscreen interaction and may allow user interface control in situations when touchscreen interaction is not practical or desirable.

This approach may comprise recovering from the memory a second application window position defined for a second application window by a second position of the portable electronic device in physical space, and

moving the portable electronic device to the second application window position, whereupon the portable electronic device displays the second application window.

It may also comprise establishing a third position of the portable electronic device in physical space and defining said third position as a third application window position for displaying a third application window on the display of the portable electronic device.

In embodiments, this approach may involve starting an interaction with one of said application windows, moving the portable electronic device to display a different one of said application windows, and completing the interaction with the different one of said application windows.

This approach can be particularly useful, as it allows interaction within an application, or between applications, on a portable device with little or no interaction by other user interface methods (such as finger movement in relation to a touchscreen). This may provide for a significantly more straightforward user interface for the user.

In some such embodiments, the first application window and the second application window relate to the same application. The interaction may then comprise cutting or copying digital content from a first document and adding it to a second document in the same application. In other cases, the second application window relates to a specific function performed on digital content. For example, this second application window may provide language translation of part of a document, or may provide a filter for image content.

In other embodiments, the first application window and the second application window relate to different applications. The interaction may then relate to selection of digital content from the first application window and processing of the digital content in the second application window. Such an interaction may relate to cutting or copying digital context from a document in a first application and inserting it in a document in a second application. Alternatively, the interaction may relate to performing a function on digital content selected from a first application in a second application.

In a third aspect, the invention provides a method of controlling a portable electronic device which comprises a display, a memory, a processing unit adapted to process application code from one or more applications and to display one or more application windows on the display, to display application windows for said applications, the method comprising:

performing the method of enabling control of a portable electronic device using the position of the portable electronic device in physical space as described in the first aspect; and

performing the method of providing a user interface for a portable electronic device as described in the second aspect.

In a fourth aspect, the invention provides a portable electronic device comprising a display, a memory, means for detecting a position of the portable electronic device in physical space, and a processing unit adapted to process application code from one or more applications and to display one or more application windows on the display, wherein the processing unit is programmed to perform the method of any of the first to third aspects.

The means for detecting a position of the portable electronic device in physical space may comprise one or more sensors internal to the portable electronic device. Said one or more sensors internal to the portable electronic device may comprise one or more of one or more accelerometers, a gyroscope and a camera.

The means for detecting a position of the portable electronic device in physical space may also comprise one or more sensors external to the portable electronic device but in communication with the portable electronic device. These may comprise one or more cameras.

The portable electronic device may for example be a cellular telephone handset, or a tablet computer.

In a fifth aspect of the invention, there is provided a method of controlling a portable electronic device using the position of the device, which device comprises a housing containing a display, a memory, a processing unit capable producing a first and a second display output using computer code, a display capable of displaying the first and second display output and a user interface that includes a user input, the method comprising the steps of: displaying on the display said first output of the processing unit using the computer code associated with the first output; detecting a predetermined input from the user input and, on detection of such input when the portable electronic device is in a first position, recording in said memory, first indicative data that is indicative of the first position of the device and of the corresponding first output and of its associated computer code; moving the portable electronic device to a second position that is different to the first position; displaying on the display said second output of the processing unit using the computer code associated with the second output; detecting a predetermined input from the user input and, on detection of such input when the portable electronic device is in the second position, recording in said memory, second indicative data that is indicative of the second position of the device and of the corresponding second output and of its associated computer code; tracking the movement of the portable electronic device, comparing the position of the portable electronic device relative to the positions recorded in the first and second indicative data and: if the portable electronic device is approximately in said first position, displaying the first output of the processing unit using its associated computer code based on the first indicative data stored in said memory and if the portable electronic device is approximately in said second position, displaying the second output of the processing unit using its associated computer code based on the second indicative data stored in said memory; wherein the computer code associated with the first output is addressable via a user interface when said the portable electronic device is in said first position and the computer code associated with the second output is addressable via a user interface when said the portable electronic device is in said second position.

In a sixth aspect of the invention there is provided a method of controlling a portable electronic device using the position of the device, which device comprises a housing containing a display, a memory, a processing unit capable producing a first and a second display output using computer code, a display capable of displaying the first and second display output and a user interface that includes a user input, the method comprising the steps of: while the portable electronic device is in a first position, displaying on the display said first display output of the processing unit using the computer code associated with the first output; recording in said memory, first indicative data that is indicative of the first position of the device and of the corresponding first output and of its associated computer code and second indicative data that is indicative of a second position that is pre-determined relative to the first position of the device and that is indicative of a second output and of its associated computer code; tracking the movement of the portable electronic device, comparing the position of the portable electronic device relative to the positions recorded in the first and second indicative data and: if the portable electronic device is approximately in said first position, displaying the first output of the processing unit using its associated computer code based on the first indicative data stored in said memory and if the portable electronic device is approximately in said second position, displaying the second output of the processing unit using its associated computer code based on the second indicative data stored in said memory; wherein the computer code associated with the first output is addressable via a user interface when said the portable electronic device is in said first position and the computer code associated with the second output is addressable via a user interface when said the portable electronic device is in said second position.

In a seventh aspect of the invention, there is provided portable electronic device comprising a display; a memory; a processor capable of producing a first and a second display output using computer code; a display capable of displaying the first and second display output and a user interface that includes a user input, wherein the processor is in communication with said memory, display and user interface and configured to: display on the display said first output using the computer code associated with the first output; detect a predetermined input from the user input; record in said memory, on detection of such input when the portable electronic device is in a first position, first indicative data that is indicative of the first position of the device and of the corresponding first output and of its associated computer code; display on the display said second output using the computer code associated with the second output; detect a predetermined input from the user input; record in said memory, on detection of such input when the portable electronic device is in the second position that is different to the first position, second indicative data that is indicative of the second position of the device and of the corresponding second output and of its associated computer code; track the movement of the portable electronic device; compare the position of the portable electronic device relative to the positions recorded in the first and second indicative data and: display the first output of the processing unit using its associated computer code based on the first indicative data stored in said memory if the portable electronic device is approximately in said first position, and display the second output of the processing unit using its associated computer code based on the second indicative data stored in said memory, if the portable electronic device is approximately in said second position; wherein the computer code associated with the first output is addressable via a user interface when said the portable electronic device is in said first position and the computer code associated with the second output is addressable via a user interface when said the portable electronic device is in said second position.

In an eighth aspect of the invention, there is provided a portable electronic device comprising a display, a memory, a processor capable of producing a first and a second display output using computer code, a display capable of displaying the first and second display output and a user interface that includes a user input, wherein the processor is in communication with said memory, display and user interface and configured to: display on the display said first output using the computer code associated with the first output; detect a predetermined input from the user input; record in said memory, on detection of such input when the portable electronic device is in a first position, first indicative data that is indicative of the first position of the device and of the corresponding first output and of its associated computer code; and second indicative data that is indicative of a second position of the device and of a second output and of its associated computer code, which second position is pre-determined relative to the first position; compare the position of the portable electronic device relative to the positions recorded in the first and second indicative data and: display the first output of the processing unit using its associated computer code based on the first indicative data stored in said memory if the portable electronic device is approximately in said first position, and display the second output of the processing unit using its associated computer code based on the second indicative data stored in said memory, if the portable electronic device is approximately in said second position wherein the computer code associated with the first output is addressable via a user interface when said the portable electronic device is in said first position and the computer code associated with the second output is addressable via a user interface when said the portable electronic device is in said second position.

It is an object of the present invention to configure a portable electronic device so that it is made easier for a user to switch the program or page operating in the foreground, for example switching from showing an output of one program to showing an output of another program or from showing one output of a program to showing another output of the same program, e.g. different pages or documents in a word processing program. A program running in the foreground is one whose output is displayed and/or that can be manipulated from the input of the device.

The solution of the present disclosure differs from previous solutions to switching between programs on a mobile device as it allows the user to set up a virtual arrangement of programs in a way that suits them at that moment in time and the means by which the switching between those programs or documents or parts thereof is achieved in a fast, natural feeling movement rather than a series of button presses.

This approach provides particular benefits in respect of interactions extending between different applications, or different elements of a single application. Such interactions—such as selection of digital content for insertion or manipulation—can be performed in a natural way that is easy for a user to achieve with a portable electronic device.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic diagram of an overhead view of three different application areas defined on a surface and arranged linearly, in accordance with an embodiment of the disclosure;

FIG. 2 is a schematic diagram of an overhead view of three different application areas defined on a surface, with a hand holding a portable electronic device hovering outside the labelled areas, showing content on the display screen, in accordance with an embodiment of the disclosure;

FIG. 3 is a schematic diagram of an overhead view of three different application areas defined on a surface, with a hand holding a portable electronic device hovering within an application area, showing content on the display screen, in accordance with an embodiment of the disclosure;

FIG. 4 is a schematic diagram of an overhead view of three different application areas defined on a surface, with a hand holding a portable electronic device hovering within application area, showing an output of a first program on the display screen, in accordance with an embodiment of the disclosure;

FIG. 5 is a schematic diagram of an overhead view of three different application areas defined on a surface, with a hand holding a portable electronic device hovering within an application area, showing an output of a second program on the display screen, in accordance with an embodiment of the disclosure;

FIG. 6 is a schematic diagram of an overhead view of three different application areas defined on a surface, with a hand holding a portable electronic device hovering within an application area, showing an output of a third program on the display screen, in accordance with an embodiment of the disclosure;

FIG. 7 is a schematic diagram of an overhead view of three different application areas defined on a surface and arranged in a haphazard manner, in accordance with an embodiment of the disclosure;

FIG. 8 is a schematic diagram of an overhead view of three different application areas defined on a surface arranged in a haphazard manner, with the areas occupying different spaces in three dimensions, in accordance with an embodiment of the disclosure;

FIG. 9 is a schematic diagram of an overhead view of three different application areas defined on a surface, with the entire area enveloped by another bounding box, all in accordance with an embodiment of the disclosure;

FIG. 10 is a schematic diagram of an overhead view of three different application areas defined on a surface, with the entire area enveloped by another bounding box, all in accordance with an embodiment of the disclosure;

FIG. 11 is a schematic diagram of an overhead view of two different application areas defined on a surface, with a hand holding a portable electronic device hovering within an application area, showing an output of a fourth program on the display screen, in accordance with an embodiment of the disclosure;

FIG. 12 is a schematic diagram of an overhead view of two different application areas defined on a surface, with a hand holding a portable electronic device hovering within an application area, showing an output of a fourth program on the display screen, with a section of program content being pressed by a user's finger, in accordance with an embodiment of the disclosure;

FIG. 13 is a schematic diagram of an overhead view of two different application areas defined on a surface, with a hand holding a portable electronic device hovering between the areas, showing content on the display, with a section of the program content being pressed by a user's finger, in accordance with an embodiment of the disclosure;

FIG. 14 is a schematic diagram of an overhead view of two different application areas defined on a surface, with a hand holding a portable electronic device hovering between above an application area, showing a program on the display, with a section of the program content now incorporated into a fifth program as it is being pressed by a user's finger, in accordance with an embodiment of the disclosure;

FIG. 15 is a schematic diagram of a block diagram of a portable electronic device that can be used in accordance with the present disclosure;

FIG. 16 is a flow chart showing a series of events;

FIG. 17 is a flow chart illustrating the process of using sensor readings to determine the movement of the device, in accordance with the present disclosure;

FIG. 18 is a flow chart illustrating the process of determining position of an electronic device and switching from one application to another, in accordance with an embodiment the present disclosure;

FIG. 19 is a flow chart illustrating the process of determining position of an electronic device and switching from one application to another, in accordance with a further embodiment of the present disclosure;

FIG. 20 is a flow chart illustrating the process of determining positions of preset application areas and saving them as application areas, in accordance with an embodiment of the present disclosure;

FIG. 21 is a flow chart illustrating the process of associating an active application with a saved application area, in accordance with an embodiment of the present disclosure;

FIG. 22 is a flow chart illustrating the process of detecting an active area, in accordance with an embodiment of the present disclosure;

FIG. 23 is a flow chart illustrating the process of storing an active area, in accordance with an embodiment of the present disclosure.

### DETAILED DESCRIPTION

The present disclosure is based on an attempt to bring in natural interactions one might expect from placing different objects on physical table (such as a magazine, a notepad and a calculator or different documents) into the digital world.

The claimed method and device allows a user to assign one of any number of programs or documents or parts thereof to a physical space in three dimensions by bringing a portable electronic device to that space and signaling to the device that the program should be pinned there. In this way, a position of the portable electronic device in physical space may be associated with an associated application window on the display. Once in this mode, each time the device is brought back close to the physical space (within a certain threshold) the program previously assigned to that space will appear digitally on the display. In this way, a number of different programs or documents or parts thereof can each be assigned a different physical space and, by moving the portable electronic device from one space to another, the user can switch between different programs or documents or parts thereof running in the foreground and displayed. The user may use the claimed method to switch between different features within the same application. For example, a keyboard application may include different keyboard languages or layouts, for example, a keyboard that is directed to the left-hand side of the screen and a keyboard that is directed to the right-hand side of the screen. By assigning each keyboard layout to a different physical space, the user may switch easily and seamlessly between keyboard layouts.

This interaction allows users to select and move content from one program to another in a natural way, greatly reducing the number of interactions required. Such “select and move” function can be performed manually by means of a copy (or cut)-and-paste operation, although part or all of the function could be undertaken automatically, e.g. by software. The interaction also enables users to carry out functions and/or change content or metadata in dependence on the movement of the device and the selection of content by the user. For example, a user may drag content from a first application area into a second application area, the result of which would be an alteration of “tags” associated with that file.

The electronic device of the claimed disclosure may be any form of electronic device. The claimed disclosure has particular utility for portable electronic devices such as, for example, smart phones, tablets and electronic reading devices. There are many other examples of portable battery-powered electronic devices that the present disclosure may relate to, some of which include a smart watch, a remote control, a laptop computer and a portable medical device. It should be understood that the claimed disclosure is not limited to portable electronic devices or to any particular power source and may relate to fixed electronic devices that may be powered by a mains power supply, such as a desktop computer.

It should also be understood that the terms “documents or parts of such documents” and “content” used herein are intended to include pages, text, documents, information, messages, spreadsheets, databases, lists, images, graphics, photographs, video, audio, web (internet or intranet) pages, and different parts thereof, and similar electronically held information and content that can be displayed.

General and specific embodiments of the disclosure will be described below with reference to the Figures.

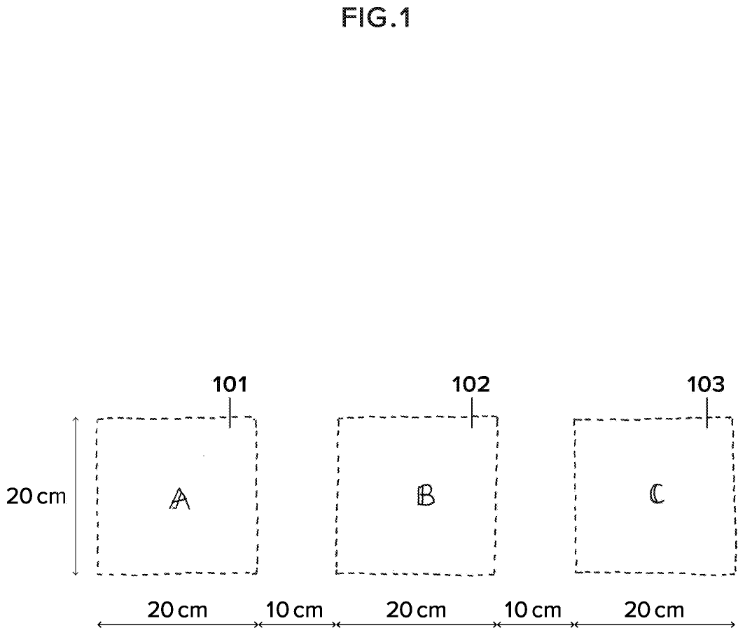

According to an embodiment, the claimed method is adopted by a user who wishes to make use of three different applications running on a portable device and switch between them easily. This example is described with referenced to FIGS. 1 to 6, wherein three application areas 101, 102, 103 are presented to the user, and a portable device 201 is being held in hand 301. The screen displayed by the operating system is designated as ‘H’, and the three different applications are designated as ‘1’, ‘2’, and ‘3’.

These application areas—also termed application windows in this specification—are regions of display provided as part of an application user interface. As discussed below, these application areas may relate to different applications running on the portable electronic device, or in some cases may be different windows generated by the same application (for example, different documents in a word processing program). As will be discussed below, these application areas are associated with different physical positions of the portable electronic device.

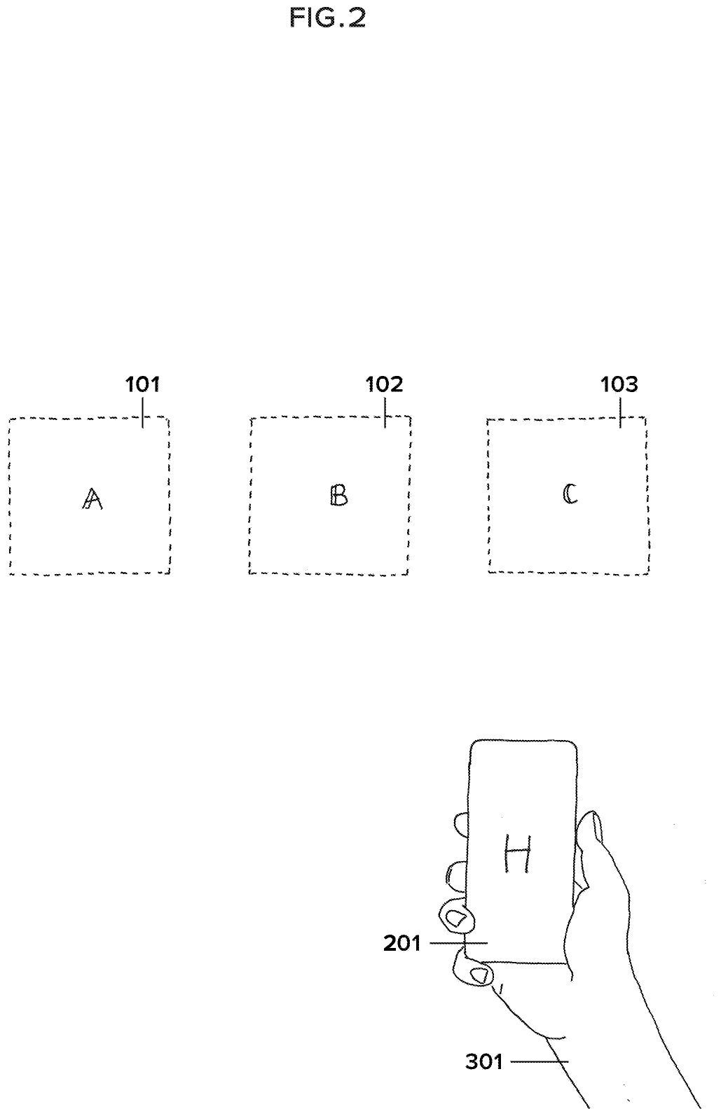

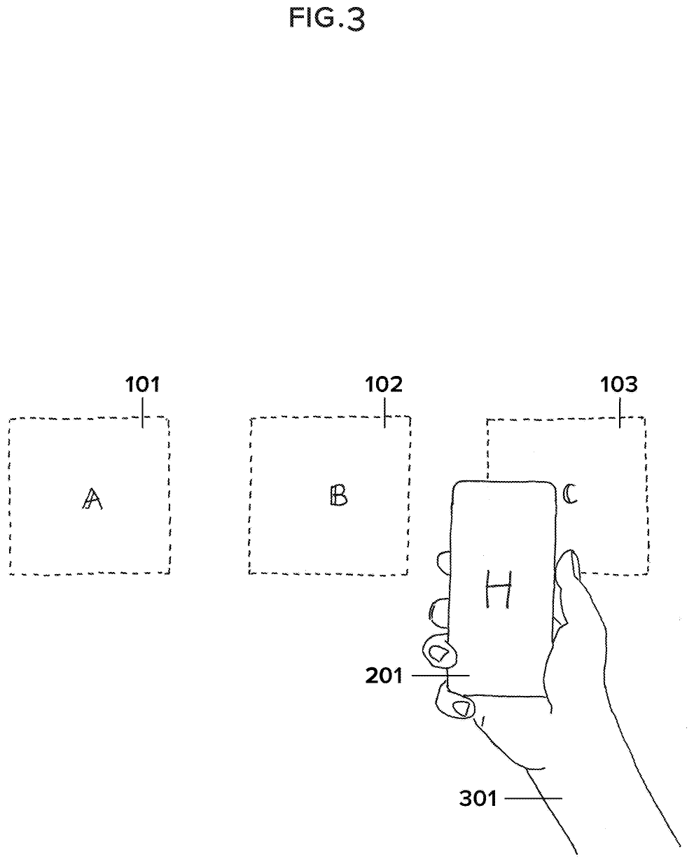

FIG. 1 illustrates three application areas 101, 102, 103 on a virtual plane in front of the user. The virtual plane may be in any orientation in 3D space but is often a flat or slanted surface, such as a desk or table top. In the present example, the three application areas are each square shaped with dimensions of 20 cm by 20 cm, and the application areas are separated by a linear spacing of 10 cm. It should be understood that the application area is not limited to being square-shaped and may instead be of any relevant shape such as rectangular or circular. In addition, the separation of the application in a linear arrangement is not limited and may vary depending on requirements and use of the claimed disclosure. In FIG. 2, the user is holding the device 201 by hand 301, away from the three application areas. At this stage the device may display any content, however in this particular example, the home screen or operating system home screen is displayed on the screen (displayed as ‘H’ for ‘Home’). FIG. 3 then illustrates how the user's hand 301 would physically approach application area 103 with the device 201. At this stage the user would interact with the device using its operating system to open the first application (application ‘1’), which will then run in the foreground of the device 201. The output of the application is shown on the screen.

It should be understood that in this case the application areas are defined relative to one other, and are not required to be fixed to a particular position in space. Advantageously, this enables the virtual layout of the application areas to be used in instances where the user and user device are travelling, for example if the user is in a moving vehicle, or if the user is on a slowly revolving platform. In such instances, the user would maintain control of the virtual environment and layout of the application areas; the user would still be able to move the device to hover over different application areas in order to switch between applications, even if moving at high speeds.

In other embodiments, the application areas may be defined relative to a physical object—for example a desk or table surface identified by a camera of the portable electronic device, or one or more sensors for detecting a geographic location. This may help the user to create a regular working pattern, where applications of different types are associated by the user with different regions of a physical space.

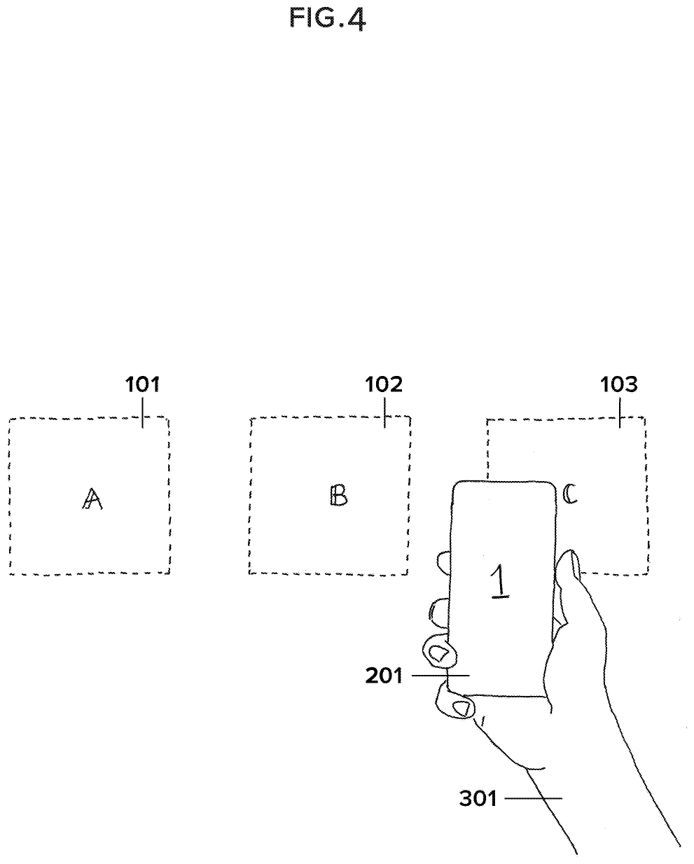

At this point, the user would instruct the device to virtually pin the first application to application area C 103, as shown in FIG. 4. The command instruction may take any form that can be sensed by the device, such as pressing one or multiple physical buttons or, if the device has a sensing screen, e.g. a touch-sensitive screen, by engaging virtual program-defined buttons on the screen. Such command instructions may include pressing a specific button on the display, or employing a predetermined press of the display, such as pressing with two fingers, or pressing with a certain pressure. The command instructions may for example include making audible commands, for example by speaking into a microphone on the device, or making visually-detectable gestures. Such command instructions inform the operating system of the device 201 that the user has enabled the mode to allow the first program to be displayed whenever the device 201 is in application area C 103.

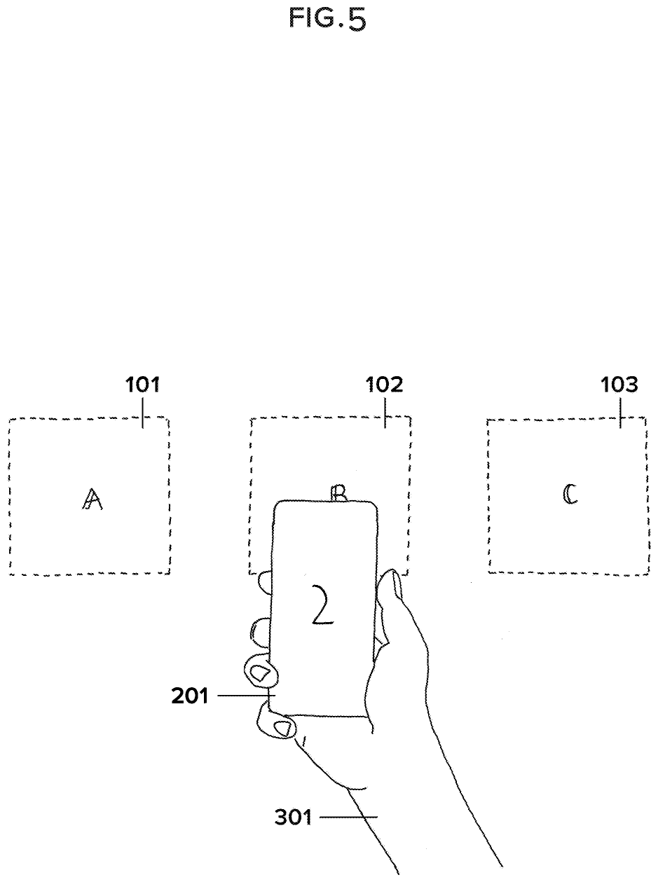

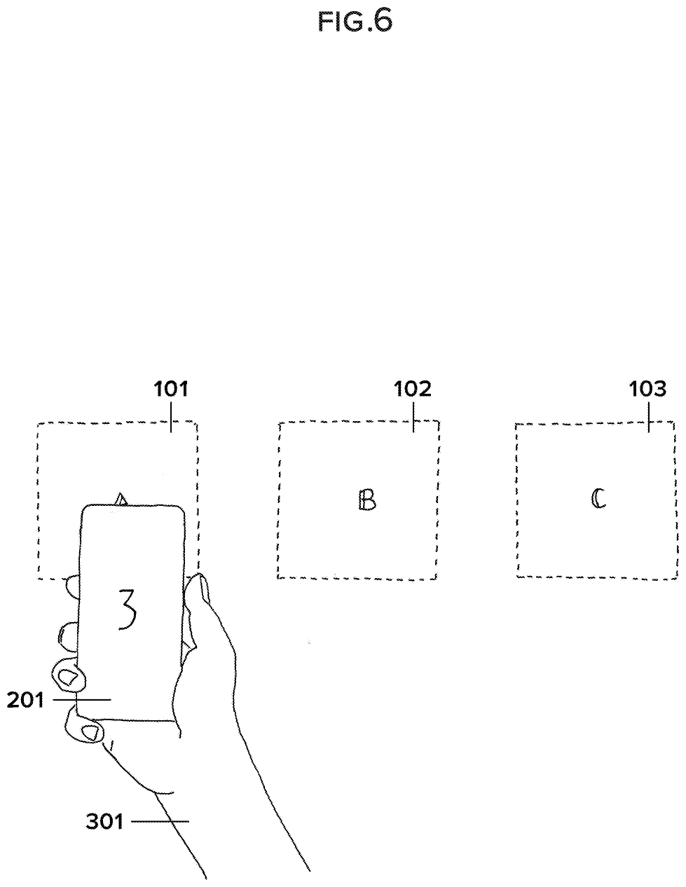

The user may then either use the first application in application area C 103, or decide to move the device 201 to a new area, such as application area B 102 as shown in FIG. 5. At this point, the user may choose to navigate to a second application on device 201 and follow similar steps to virtually pin it to application area B 102, as shown in FIG. 5. Identification of a second application may happen in a number of ways—for example, the operating system may offer up a choice of applications to the user predictively, or offer a search box to the user. Furthermore, the user may then choose to navigate to a third application on device 201 and follow similar steps to virtually pin it to application area A 101, as shown in FIG. 6.

Once the above process of virtually pinning an application to each of the three application areas has been completed, the user may move device 201 freely in physical space and hover the device 201 of the application area associated with the application that the user wishes to switch to. Each time the device 201 appears in the application area 101, it will bring program 3 into view on the display of the device. Similarly, each time the device 201 is moved into application area 102, program 2 will be shown on its display, and each time the device 201 is moved into application area 103, program 1 will be shown on its display. Advantageously, this enables the user to switch between programs rapidly and easily by simply moving the device 102 in physical space.

It should be noted that once an application is in focus since the device is in a particular application area, the application maintains its focus on the device until the device is moved into another application area associated with another application. An advantage of this feature is that moving the device out of that application area, intentionally or unintentionally, will not switch to a new application or close the application; thus, this improves usability.

The above method relates to switching between different programs or applications by moving the device 102 between different application areas, 101, 102, 103. It should be understood that the method may be used for switching between different documents or parts thereof or sub-programs within a single program or application.

Programs or applications used on the electronic device could be any suitable application that outputs information, such as an email (or other communication) application, a text messaging application, a calendar application, a navigation application, an address book or contacts listing application and so forth. It is also possible that sub-sections of programs, or areas within a program could be navigated in this way. Some examples of applications and programs in which the claimed method and device may be used are described below.

The method could be used on a text messaging application in which the user can control the selection of emoji characters each assigned to a different application area. For example, the user may select an emoji which causes app spaces containing further emoji characters to appear in close proximity to the device. The user navigates the device to the emoji of their choice, selects it with their finger and drags it as they move the device back to the starting point to drop it into their text message. A similar system could be used inside a reading application in which a user selects a word and then by moving the device pastes the word into a different part of the application.

The method could be used in a photo application where the user has access to thumbnails of their images and they can select them and drag them into another app space to create a photo collage, or sort them into different folders which are represented by app spaces.

Another example is an e-mail application where a user can write a search term and then move the device left or right, or in any orientation, to search for the search term in different e-mail accounts. A further example is using the method on a sketching application where the user can use app spaces to hold different virtual drawing tools and represent layers of their drawing in the vertical dimension.

The present method could also be used with a note keeping application where an app space is permanently fixed to the side of the device and users can drop content into it. A further example is use of weather application where the user can use different app spaces to represent the different hours in the day and visualise the change in the weather conditions.

The present disclosure may be useful for collaborative purposes. For example, content may be dropped into a space shared with another user, and the user could then move their device to the shared space to pick up content.

It is also possible for external devices, other than a mobile electronic device, to activate the process. For example, a coffee machine may have a complicated user interface. If a user taps their mobile phone onto the coffee machine this may establish and active area with associated application areas in close proximity to the coffee machine. This would then enable the user to interact with an interface relating to the coffee machine, for example to choose coffee style. Another example in which an external device may activate the process is in an automobile. In this case, tapping the mobile phone onto the bonnet could activate an active area around the vehicle, and the user could move their device around the car to open different screens or areas within a configuration application. For example, moving the device towards the wheels could help the user to find information about tyre pressure, or moving the device towards the sunroof could result in finding additional information about the sunroof as well as options for controlling it.

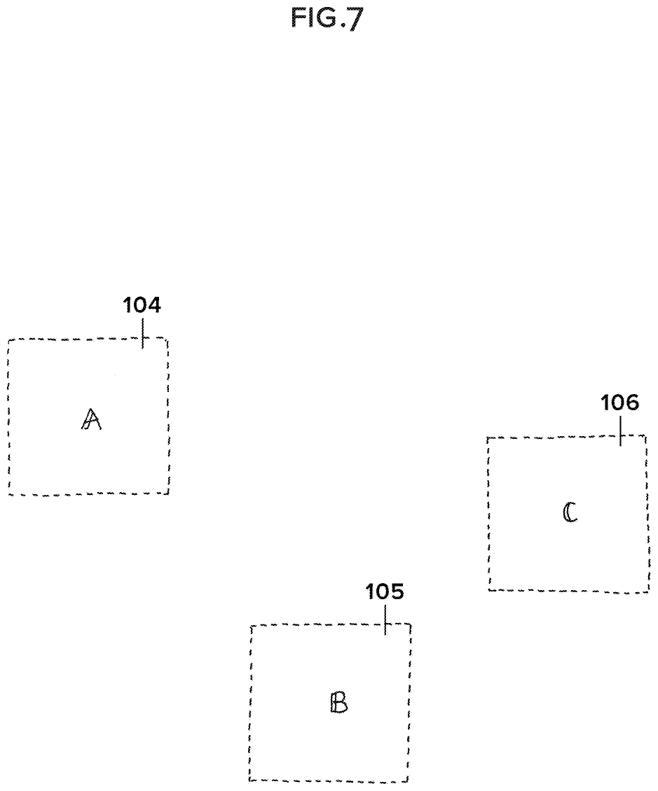

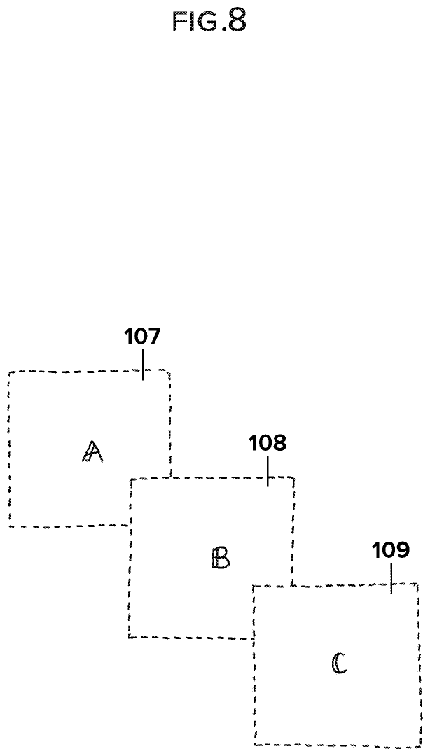

The application areas 101, 102, 103 referred to in the above description and in FIGS. 1 to 6 are laid out on a horizontal virtual plane. It is to be understood that the application areas may be arranged in any orientation and position relative to one another. For example, the application areas 104, 105, 106 in FIG. 7 are arranged in a haphazard manner. The application areas are not limited to being defined on a single plane. A further example is shown in FIG. 8: the application areas 107, 108, 109 in FIG. 8 occupy different spaces in three dimensions and are arranged on multiple different planes in three dimensional space.

For frequently recurring tasks, the user may choose to save the virtual arrangement of two or more applications areas to the memory of the electronic device. This can be seen as analogous to arranging a workspace on a computer desktop and saving its arrangement for use at a later date. This would be beneficial to the user as it would enable the user to arrange a workspace without repeating the process of pinning each application to an application area.

According to an embodiment, the claimed method enables definition of an active area to which the user may return the device after having to move it away.

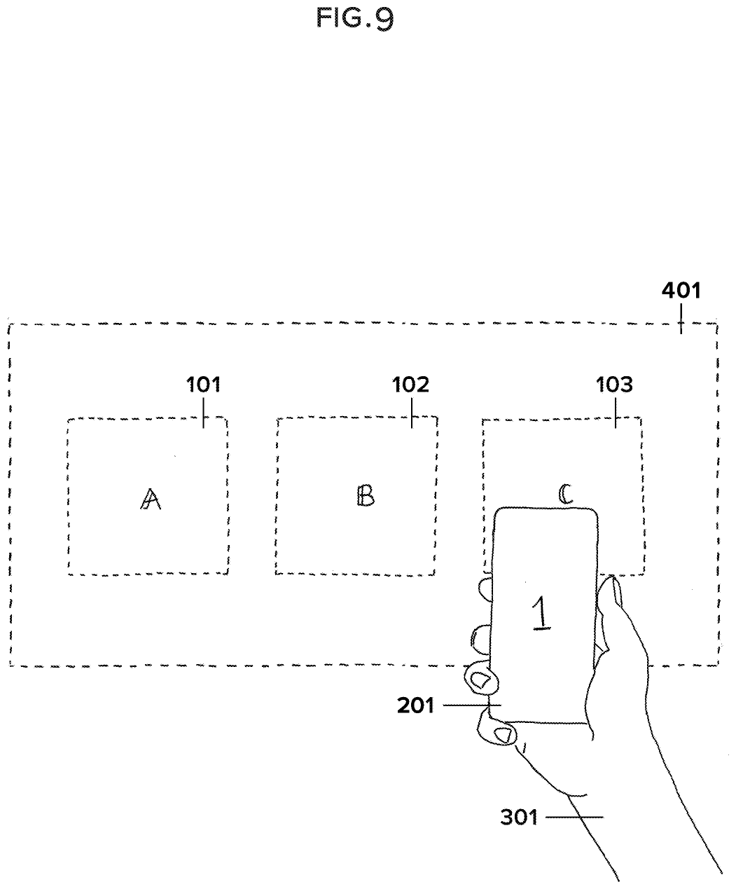

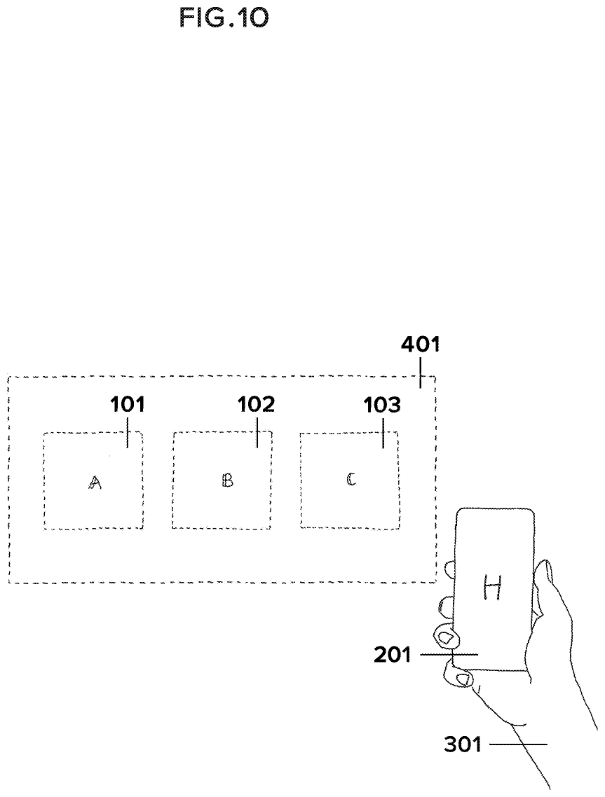

FIG. 9 shows a user with device 201 occupying application area 103, whereby application 1 is displayed on the screen of the device 201. All three application areas 101, 102, 103 are bounded by a bounding box which is known as the active area 401. The active area may be, for example, an area similar to that of a user's physical desk or part of the desk. This active area may correspond to a working region of physical space for the portable electronic device. The user may then decide to move the device 201 away from the active area 401, as shown in FIG. 10. The effects of moving the device 201 to outside of the active area 401 on the device or the applications on the device are programmable by the user. Two exemplary effects are as follows:
i) the device 201 leaves the above-described mode, reverts to its original settings and displays the operating system home page ‘H’ on the screen.

ii) the device continues to operate in the above-described mode, however it remaps the positions of each application area 101, 102, 103 to centre around the current physical location of the device. This enables the user to continue using the above-described mode if the user decides to leave the initial active area and walk while using their device or work at a different location.

The device can detect the movement between areas 101, 102, 103 and 401 using motion sensors within the device and can record the positions of the areas 101, 102, 103 and 401 in a temporary memory, for example random-access memory (RAM), or in the more permanent memory. The sensors will register all motion of the device, and an algorithm, which is known and already in widespread use in such portable devices, will be able to reasonably detect if the user is moving. This may be because they are on a train, in a car, on a bicycle or walking. The algorithm will be able to filter out this background movement, and allow the user to benefit from the above-described mode even while they are moving.

According to some embodiments, the claimed method enables the user to take some content from one application and bring it into another application. In computing, this is typically known as copy and paste, or cut and paste, or moving or copying a file or content.

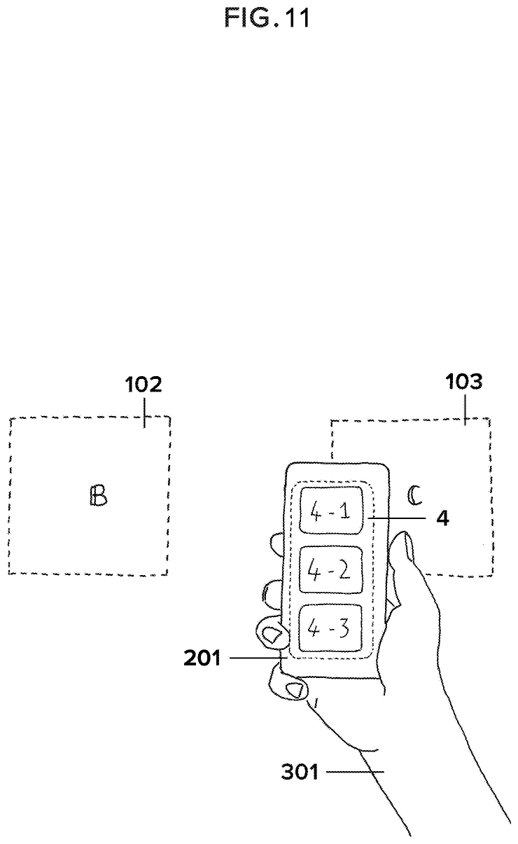

Referring to FIG. 11, it is assumed that the user has set up a first application 4 in application area C 103 and a second application 5 in application area B 102, as described in the previous example. The first application 4 may be made up of multiple types of content, including, but not restricted to, text, audio, video and images. In FIG. 11, the display output of the first application 4 is made up of different pieces of content, labelled as 4.1, 4.2 and 4.3, wherein 4.1 may be text, 4.2 may be an image, and 4.3 may be another section of text. The second application 5 is configured to accept the introduction of content. It could be, for example, a note-taking program or a word processor.

In this example, the method enables the user to take some content, e.g. 4.2, from the first application 4 and place it into the second application 5. Existing systems would require the user to select the required content in the first application and store it in memory; then the user would have to manually navigate to the second application and select the “paste” function to copy or move the content from memory into the second application.

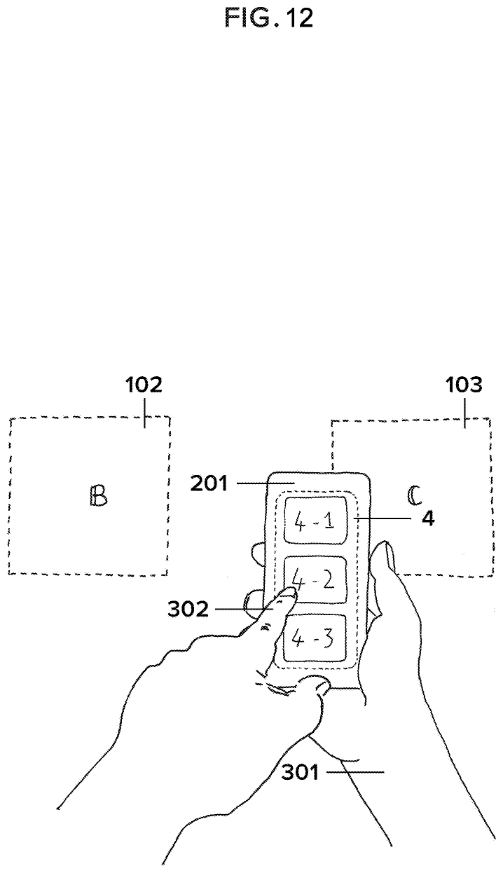

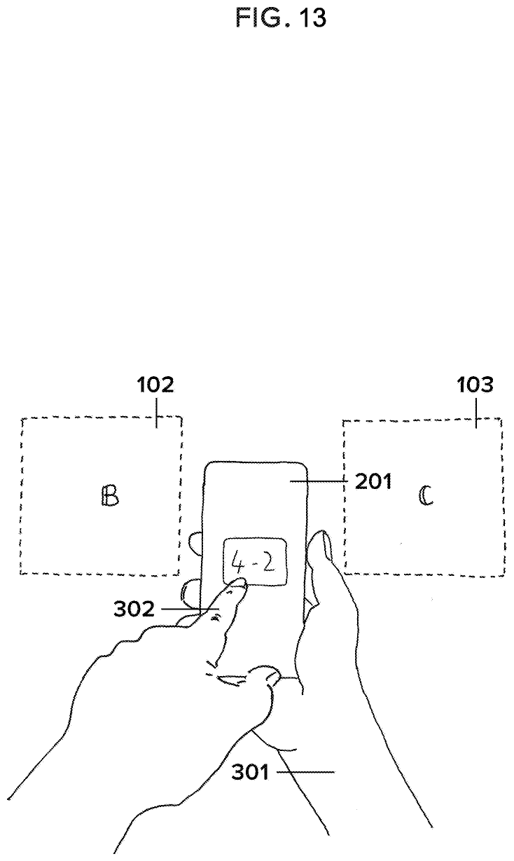

As shown in FIG. 12, in the present disclosure the user can place their finger 302 onto the piece of content 4.2 to be copied, thereby instructing the device that they wish to interact with this piece of content. As described previously, the command instruction may take any form that can be sensed by the device. The user can then move the device 201 away from application area C 103, while their finger remains on the content 4.2. The application areas 102, 103 may be separated by some distance, as shown in FIG. 13. In this case, the user's finger remains on the content 4.2 while the device is moved away from the first application area 103, into a transitional space, and towards the second application area 102. It should be noted that, for example, if any one of the edges of the first application area were aligned with any one of the edges of the second application area, the user's finger would remain on the content and the device would move directly into the second application area from the first application area, with no transitional space in between.

At this point, the remainder of the first application 4, other than content 4.2, disappears from view on the display, leaving only the chosen content 4.2. In this space, the device 201 is between applications areas 102, 103.

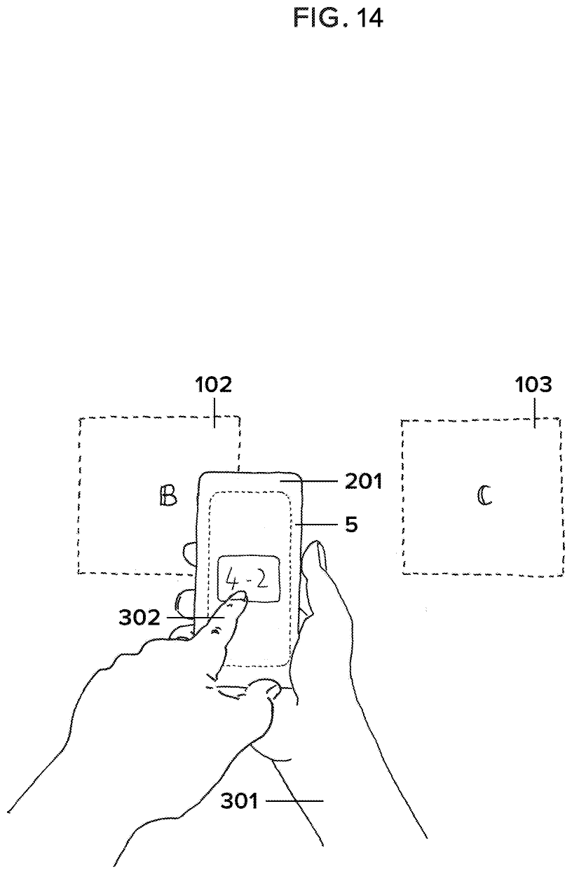

The user can then enter the device 201 into application area 102, as shown in FIG. 14. The screen is updated to show the output display of the second application 5 with the chosen content 4.2 from the first application 4 integrated into the second application 5. The chosen content 4.2 may, for example, be a block of text from the first application 4 which has now become part of the second application 5.

Any type of digital content can be transferred from program to program in this way, in some cases moving it from one place to another, and in other cases replicating it as is desired by the user or the task at hand. The above example illustrates how a user can transfer content from one application to another. The claimed method and system also enables a user to alter content and metadata when dragging content from application to another. The drag and drop motion may carry out a function in dependence on the movement of the device and the selection of content by the user. This speeds up and expands the interactions available to the user. For example, a translator application may be pinned to a second application area and an article may be pinned to a first application area. The user may drag a word or paragraph written in English in the article towards the second application area in which the translator application is pinned; when the user's finger is released from the display of the device, the text is translated into a predetermined language. In this way, the interaction may achieve a specific functional result associated with taking digital content to the second application area. Another example of a second window with a functional role would be a photographic filter—selection of an image in the first window and movement to the second window could then result in application of the filter (for example, providing a black and white version of a colour image).

The first window and the second window linked by the interaction may be part of the same application—for example, by moving or copying text from one document to another within the same word processing program. Cutting or copying, and subsequently pasting, digital content is however only one example of an interaction starting in one application window and continuing in another. These interactions may not involve extraction of digital content from the first window, but may, for example, provide a functional result associated with the first window representing a particular entity (for example, the first window could represent a user document such as a passport, and the second window could be a form that will be autocompleted with details associated with the user document identified by the first window).

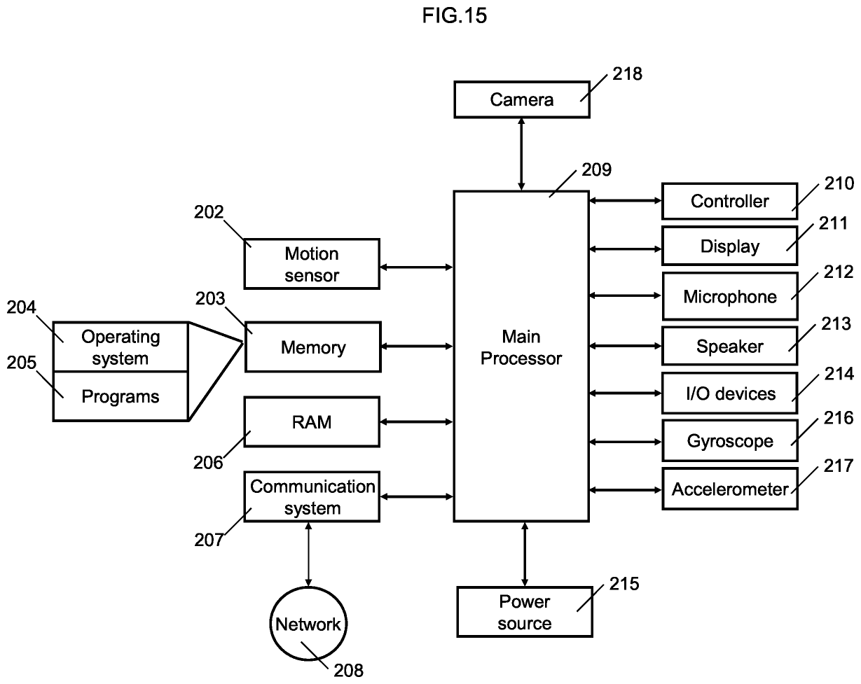

The electronic device of the claimed disclosure may be any form of electronic device. A schematic block diagram of an example of a portable electronic device 201 is shown in FIG. 15. The portable electronic device 201 includes multiple components, such as a processor 209 that controls the overall operation if the portable electronic device 201. The main processor receives signals from, and send signals to, a motion sensor 202, a memory 203, which stores not only the operating system of the portable electronic device 204 but also programs or applications 205. The user can choose the program to be run at any one time and multiple programs can be running simultaneously. The main processor 209, also communicates with random access memory (RAM) 206, and a communications system 207 which may in turn be connected to a network 208, such as the Internet or an intranet.

The portable electronic device also includes a controller 210 and a display screen 211, a microphone 212, a speaker 213 and input/output (I/O) devices 214. The portable electronic device also includes an accelerometer 216 and a gyroscope 217. The portable electronic device is powered by a power source 215. The electronic device may also include a camera 218 or multiple cameras.

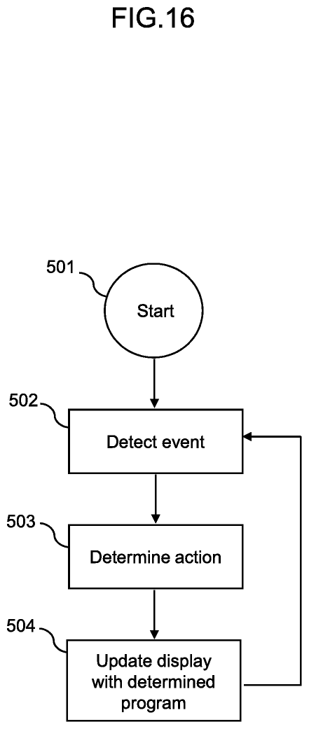

A flowchart illustrating a method of controlling an electronic device 201 is shown in FIG. 16. The method may be carried out by computer readable code executed, for example, by the processor 209 of the device. The method may contain additional or fewer processes than shown and/or described, and may be performed in a different order. First, an event is detected 502, for example a movement of the device is detected. An action is then determined 503 based on the rules set out in the computer code. Then the display is updated with the relevant information 504.

The microprocessor 209 of a device can track the movement and location of the portable electronic device 201 whenever any application is pinned to an application area 101, 102 103. The device can use one or more of an accelerometer, or group of accelerometers, or a gyroscope to determine position and orientation. Accelerometers will typically be used to detect movement in a given direction—three orthogonal accelerometers are typically used to determine movement in three dimensions. A gyroscope will typically be used to provide an orientation for a device in physical space.

Similar results may also be achieved by a camera internal to the portable electronic device 201—for example, the camera may be adapted to recognise a specific physical surface (such as a table or a desk), so that application windows may be associated with regions of this physical surface. The camera may, instead of or in addition to recognising a physical surface, determine its surroundings and subsequently determine motion based on the movement relative to the determined surroundings.

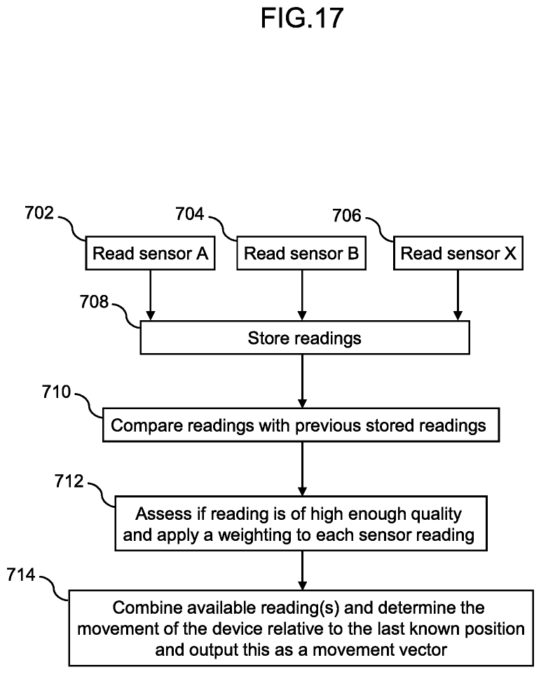

FIG. 17 illustrates the process of using sensor readings to determine the movement of the device. The device reads 702, 704, 706 and stores 708 readings from a sensor or multiple sensors. The readings are then compared 710 with previously stored readings. The readings may be assessed 712 as to the quality of the reading and a weighting may be applied to each one. The available readings are then combined 714 and the movement of the device relative to the last known position is determined 714 and outputted as a movement vector.

The claimed method may, therefore, consider one or more inputs in determining if movement has occurred and in calculating a motion vector. For example, the device may use built-in motion sensors, such as the accelerometer(s) and gyroscope, or an in-built camera. The device may, separately or in addition to, use capacitance, radio signal information, magnetic radiation, temperature, ambient light, electromagnetic radiation, RFID, GPS, Wi-Fi, Bluetooth and/or NFC if available. The quality of these signals can be determined in order to decide which information to use. For example, a reading from a photo taken in low light may be of low quality and thus ignored. Another example is if the reading suffered from noise interference it may be ignored. The method may apply a weighting to the different readings and consider some to a greater extent than others.

Sensors external to the device may determine a physical position associated with the device. For example, it is possible that a separate device, such as a portable camera, may sense the position or movement of the portable electronic device 201 by the user. In this case, it is possible that the information about that movement is communicated to the device 201 electronically, removing the need for an in-built motion sensor on the device, or working in conjunction with it. The external device may be any suitable device that can sense position or movement. For example, this may include using sensors in a smart watch or fitness band. The physical position of a device may be tracked using information from multiple external devices, whereby the multiple external devices may comprise different devices. For example, one or more smart devices may be used via a Wi-Fi connection to track the position of an electronic device.

The claimed method and device is able to track the position of the device relative to previous positions of the device using a wide range of methods available to the device, ranging from motion sensors to cameras, accelerometers, gyroscopes, magnetometers, and other means of connectivity such as Bluetooth, Wi-Fi or radar. The position of the device can be tracked either by determining the absolute position of the device or the relative displacement of the device.

The device may be set to a ‘determine position’ mode in which sensors, such as the accelerometer, can be continuously read in order to store the motion vectors associated with any movement. In situations where this may not be favourable or viable, the device may use the camera to take a snapshot of the surrounding area and store a model of the environment. It may then take a further snapshot of the area and compare the second snapshot to the model of the environment in order to determine the position of the device.

Furthermore, using motion sensors on the electronic device, the device would be able to determine that it is moving in a specific direction. The claimed method and device may also compute an approximate assumption of the distance travelled, for example by integration of the acceleration detected by the accelerometer over time to determine the velocity, and integration of the velocity over time to determine displacement. Other sensors such as, for example, the magnetometer and/or the gyroscope may be used in this calculation to improve accuracy.

Displacement of the electronic device may be calculated using readings from computer vision techniques including, but not limited to, a camera. Such techniques may be combined with an assumed displacement calculated by other means if the quality of the reading from the computer vision technique is low. Furthermore, displacement of the electronic device may be calculated using structured light and/or time of flight systems by which a three-dimensional model can be determined from a combined input of several camera readings. In this example, displacement of the device can be inferred from the three dimensional model created.

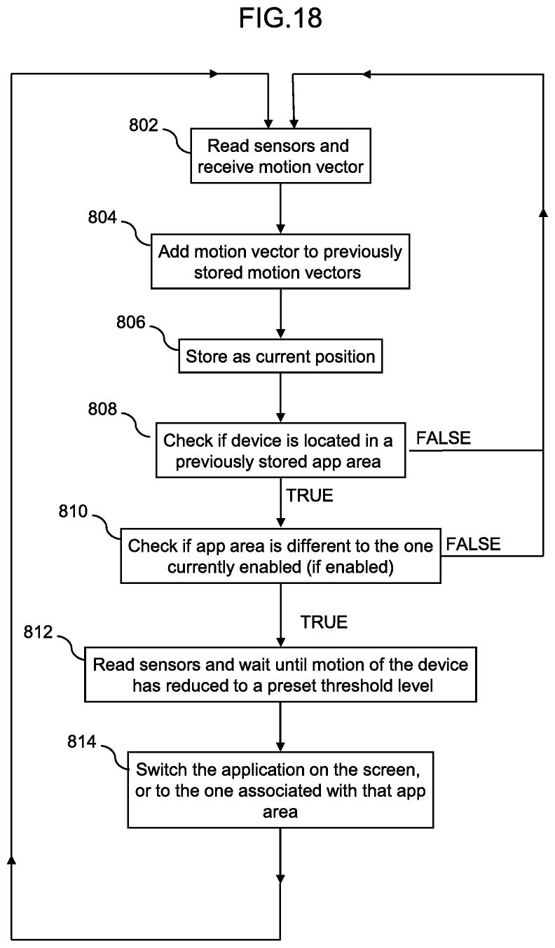

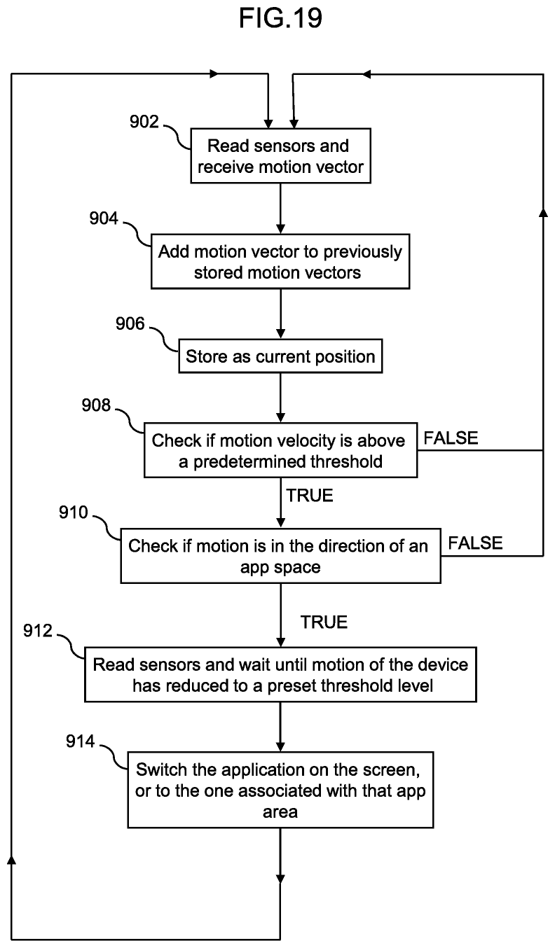

FIGS. 18 and 19 illustrate two ways by which the user can switch from a first application to a second application on an electronic device, in accordance with the present disclosure. Starting with the flowchart on FIG. 18, the device reads 802 the sensors and receives 802 a motion vector. The motion vector is added 804 to previously stored motion vectors, and the current position of the device is stored 806. A snapshot of the location of the device at any time is built up using this method in order to track the position of the device. Then, a check 808 is carried out in order to check whether the device is located within an application area that has been previously stored. If it is, then a second check is carried out in order to check 810 whether the application area is different to the application area currently enabled. A positive result from this check may then cause the device to read 812 the sensors and await the moment in which the motion of the device has reduced to a preset threshold level, which indicates that the motion of the user's device is slowing down, before switching 814 from the first application to the second application associated with the current application area. These features enable a better user experience.

Turning to FIG. 19, the device reads 902 the sensors and receives 902 a motion vector. The motion vector is added 904 to previously stored motion vectors, and the current position of the device is stored 906. A snapshot of the location of the device at any time is built up using this method in order to track the position of the device. Then, a check 908 is carried out in order to check if the motion velocity and/or position of the device is above a predetermined threshold. If this check is passes positively, a second test will check 910 if the motion is in the direction of or directed toward an application area. A positive result from this check may then cause the device to read 912 the sensors and await the moment in which the motion of the device has reduced to a preset threshold level, which indicates that the motion of the user's device is slowing down, before switching 914 from the first application to the second application associated with the current application area.

Using this method of switching from a first application to a second application, any chosen content, for example, a block of text, can be transferred from the first application to the second application, as described with reference to FIGS. 11-14.

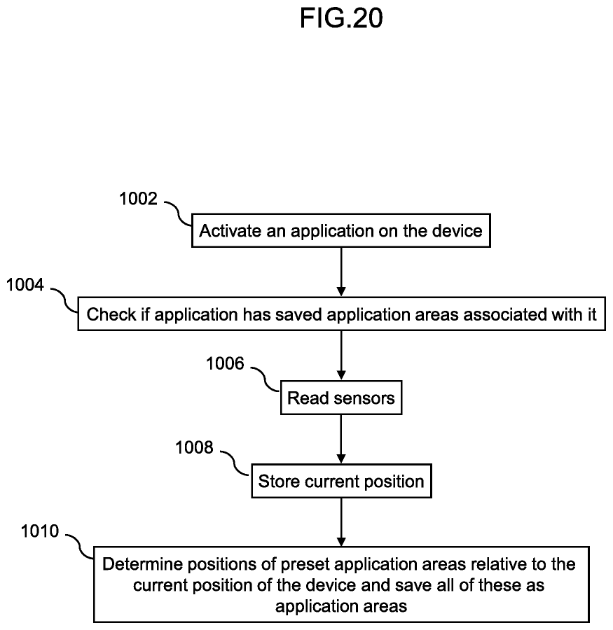

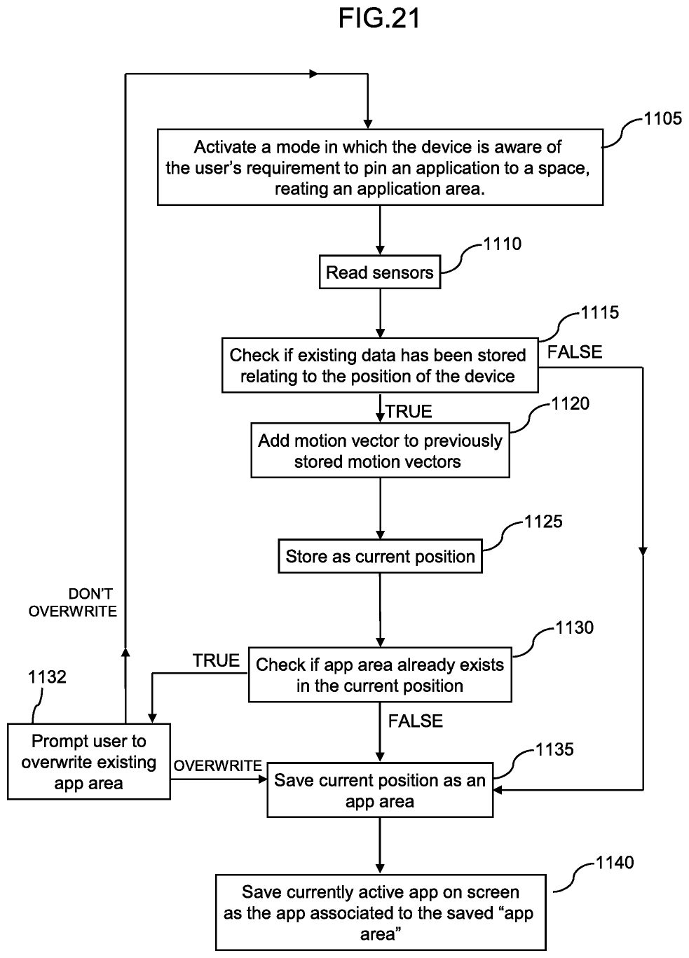

FIGS. 20 and 21 describe the saving of presets and pinning an application to an application area in further detail. Once it is established that the device is in a particular area, an application can be ‘pinned’ or embedded into the application area by a simple key press, a virtual key press, a spoken command on any other input type.

For the saving of presets, first an application is activated 1002 on the device. Next, a check is carried out to check 1004 if the activated application has any saved application areas associated with it. The sensors are read 1006 and the current position stored 1008. The positions of preset application areas are determined 1010 relative to the current position of the device and all of them are saved as application areas.

The application itself can take any of the following states: accept user input to save new active areas and application areas; load preset application areas; active mode where the device is tracking its position and switching applications based on its position relative to active areas; add an additional application area and save it; change an existing app area which has been saved; remove a saved application area; save the current application areas as a new preset.

The user may select one or more applications from a list or graphical user interface and arrange the applications by, for example, dragging and dropping application icons to the left and right of each other. The graphical user interface may display a zoomed out view of all of the available applications. This enables the user to set up a workflow of applications and corresponding areas quickly and efficiently and without the user having to open each application.

For pinning an application to an application area, the user or system first activates a mode in which the device is aware of the user's requirement to pin an application to a space. An application area is created. The sensors are read 1110 and a check is carried out to check 1115 if existing data has been stored relating to the position of the device. If existing data has been stored relating to the position of the device, the motion vector is added 1120 to previously stored motion vectors and the current position is stored 1125. The next step is to check 1130 is an application area already exists in the current position if the current position is known. A negative result of the check at step 1115 also results in step 1130 being carried out. A positive result of step 1130 leads to prompting 1132 the user to overwrite the existing application area. At this stage, the application may not be overwritten if it is a system application, or a locked application space which cannot be overwritten by the user. For example, an application may lock a particular space for a certain aspect of the application such as a calculator, but allow a user to pin new functions around the locked space. However, the application may not allow a user to pin a new function in the locked space. Instead, a notification may be displayed on the screen of the device to notify the user to move the function to another space.

Once an existing application area is overwritten, the current position is saved 1135 as an application area. A negative result of the check at step 1130 leads to the current position being saved 1135 as an application area. Lastly, the application that is currently active on the screen of the device is saved 1140 as the application associated to the saved application area.

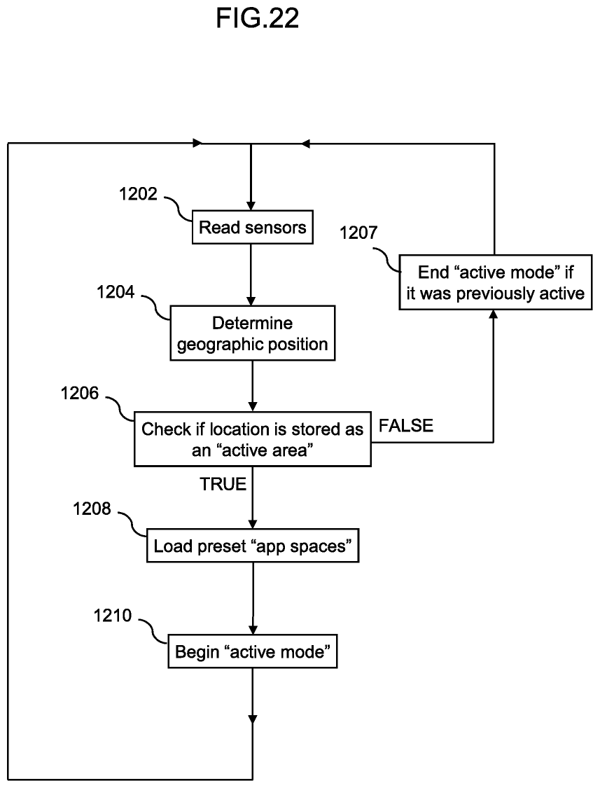

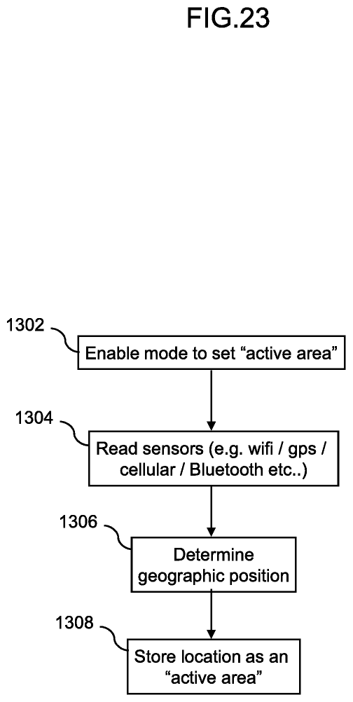

FIG. 22 illustrates the process of detecting an active area, and FIG. 23 illustrates the process of storing an active area. Starting with FIG. 22, the process of detecting an active area begins by reading 1202 the sensors and determining 1204 the location and/or geographic position of the electronic device. The next step is to check 1206 whether the location is stored as an active area. If the check is positive, the preset application areas are loaded 1208 and the active mode, in which the device is continuously tracking the device, is activated 1210. If the check for whether the location is stored as an active area is negative, the active mode of the device is terminated 1207 if it was previously running. Turning to FIG. 23, the process of storing an active area involves enabling 1302 the mode to set active area, reading 1304 the sensors and determining 1306 the geographic position of the device and then storing 1308 the location an active area.

Many modifications may be made to the above examples without departing from the scope of the present invention as defined in the accompanying claims.

1. A method of enabling control of a portable electronic device using the position of the portable electronic device in physical space, which device comprises a display, a memory, a processing unit adapted to process application code from one or more applications and to display one or more application windows on the display, the method comprising the steps of:
establishing a first position of the portable electronic device in physical space and defining said first position as a first application window position for displaying a first application window on the display of the portable electronic device, and
establishing a second position of the portable electronic device in physical space and defining said second position as a second application window position for displaying a second application window on the display of the portable electronic device,
whereby subsequent movement of the portable electronic device between the first and second positions is adapted to change an application window displayed on the display between the first application window and the second application window.

2. The method of claim 1, wherein establishing a first or a second position comprises placing the portable electronic device in said position, activating an application to be associated with the corresponding application window, and recording said position as the position associated with the corresponding application window.

3. The method of claim 1, further comprising defining a working region of physical space comprising at least the first position and the second position, and establishing an application window area corresponding to the working region.

4. The method of claim 3, wherein the first position and the second position are defined relative to the working region of physical space.

5. The method of claim 1, wherein the first position and the second position are defined relative to a physical object.

6. A method of providing a user interface for a portable electronic device, which device comprises a display, a memory, a processing unit adapted to process application code from one or more applications and to display one or more application windows on the display, the method comprising the steps of:
recovering from the memory a first application window position defined for a first application window by a first position of the portable electronic device in physical space, and
moving the portable electronic device to the first application window position, whereupon the portable electronic device displays the first application window.

7. The method of claim 6, comprising recovering from the memory a second application window position defined for a second application window by a second position of the portable electronic device in physical space, and
moving the portable electronic device to the second application window position, whereupon the portable electronic device displays the second application window.

8. The method of claim 6, comprising establishing a third position of the portable electronic device in physical space and defining said third position as a third application window position for displaying a third application window on the display of the portable electronic device.

9. The method of claim 6, comprising starting an interaction with one of said application windows, moving the portable electronic device to display a different one of said application windows, and completing the interaction with the different one of said application windows.

10. The method of claim 9, wherein the first application window and the second application window relate to the same application.

11. The method of claim 10, wherein the interaction comprises cutting or copying digital content from a first document and adding it to a second document in the same application.

12. The method of claim 10, wherein the second application window relates to a specific function performed on digital content.

13. The method of claim 12, wherein the second application window provides language translation or a filter for image content.

14. (canceled)

15. The method of claim 11, wherein the first application window and the second application window relate to different applications.

16. The method of claim 15, wherein the interaction relates to selection of digital content from the first application window and processing of the digital content in the second application window.

17. The method of claim 16, wherein the interaction relates to cutting or copying digital context from a document in a first application and inserting it in a document in a second application or the interaction relates to performing a function on digital content selected from a first application in a second application.

18.-19. (canceled)

20. A portable electronic device comprising a display, a memory, means for detecting a position of the portable electronic device in physical space, and a processing unit adapted to process application code from one or more applications and to display one or more application windows on the display, wherein the processing unit is programmed to perform a method of enabling control of a portable electronic device using the position of the portable electronic device in physical space, which device comprises a display, a memory, a processing unit adapted to process application code from one or more applications and to display one or more application windows on the display, the method comprising the steps of:
establishing a first position of the portable electronic device in physical space and defining said first position as a first application window position for displaying a first application window on the display of the portable electronic device, and
establishing a second position of the portable electronic device in physical space and defining said second position as a second application window position for displaying a second application window on the display of the portable electronic device,
whereby subsequent movement of the portable electronic device between the first and second positions is adapted to change an application window displayed on the display between the first application window and the second application window.

21. The portable electronic device as claimed in claim 20, wherein the means for detecting a position of the portable electronic device in physical space comprises:
one or more sensors internal to the portable electronic device, wherein said one or more sensors internal to the portable electronic device comprise one or more of one or more accelerometers, a gyroscope and a camera; and/or
one or more sensors external to the portable electronic device but in communication with the portable electronic device, and wherein said one or more sensors external to the portable electronic device comprises a camera.

22.-24. (canceled)

25. The portable electronic device as claimed in claim 20, wherein the portable electronic device is a cellular telephone handset or a tablet computer.

26. (canceled)
